(19) United States
(12) Patent Application Publication
(10) Pub. No.: US 2011/0321107 A1
(43) Pub. Date: Dec. 29, 2011

(54) System and Method for Interactive Use of Cable Television Devices and Other Devices

(76) Inventor: Clayton Banks, New Rochelle, NY (US)

(21) Appl. No.: 13/041,062

(22) Filed: Mar. 4, 2011

Related U.S. Application Data
(60) Provisional application No. 61/310,469, filed on Mar. 4, 2010.

(51) Int. Cl. H04N 7/173

(52) U.S. Cl. 725/110

(57) ABSTRACT

Systems, methods, and computer program products are described for sending interactive content from a cable television device to another device such as a mobile device or a computer device. A cable television device receives an input request from a consumer, using a TV remote control, in response, e.g., to an advertisement displayed on a TV. The cable television device transmits the consumer's input request and electronic address (e.g., a telephone number) to a server, which generates content on the server. The server transmits the content to the other device associated with the electronic address. The content may comprise interactive content related to the advertisement displayed on the TV, such as an internet URL or link to content or an item such as a song or software that can be electronically delivered to the device.

This application claims the benefit of U.S. Provisional Patent Application No. 61/310,469 filed Mar. 4, 2010 titled “System and Method for the Interactive Use of Cable Television Devices and Other Devices,” which is incorporated herein in its entirety by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### EXHIBITS

Exhibits A through E filed herewith form part of this application, and the disclosure of this application includes Exhibits A-E.

### BACKGROUND OF THE INVENTION

The invention disclosed herein relates generally to the field of interactive cable television devices and other devices. Examples of cable television devices include a standard television set (“TV”) and set-top box (“STB”) used to control a TV, while examples of other devices include devices which can receive content over a network, including mobile devices such as a standard cell phone, or smartphone with PC-like functionality (collectively “cell phone”), and computer devices such as personal digital assistants, laptop and palm computers, tablet computers, PCs, etc. These devices may receive content wirelessly and/or through a wired connection. For example, a cell phone may receive content wirelessly via a cellular network, and a computer device my receive content over the Internet.

More specifically, embodiments of the invention relate to systems, methods, and computer program products for the interactive use of a cable television device, e.g., the STB, and other devices, such as sending interactive content from the cable television device to the other device. Examples of sending interactive content from the cable television device to the other device include, in the case of a cell phone, e.g., sending a Short Message Service message (“SMS”) such as a text message or picture message, or a Multimedia Messaging Service message (“MMS”) and in the case of a compute device, e.g., sending an email or a web page.

### SUMMARY OF THE INVENTION

Throughout, reference is made to an embodiment or embodiments of the invention. Applicants do not intend, and it is to be understood, that the invention disclosed herein is not limited to such embodiments.

Embodiments of the invention described herein provide for systems, methods, and computer program products for sending content from a cable television device to another device.

In some embodiments, the transmitted content comprises interactive content, e.g., an internet URL or link to multimedia content or a bar code, etc. In some embodiments, the content is related to an advertisement displayed on the TV.

According to one or more embodiments of the invention, sending interactive content from a cable television device to another device comprises: receiving an input request from a consumer in response to content displayed on a TV; transmitting the consumer's input request and an electronic address, e.g., telephone information and/or email information, and/or an Internet address, or a web server address, to at least one computer; which generates or causes to be generated content in a format compatible with the other device, e.g., as or as part of an SMS, or an MMS, or an email, or a URL, or a web page, etc., and transmitting the content to the other device associated with the electronic address. In some embodiments, the content comprises with interactive content and in some embodiments the interactive content is related to the content displayed on the TV, e.g., some form of advertising.

In some embodiments, the content may comprise an item or items for purchase. In these embodiments, the purchased item(s) or content which can be used to retrieve the purchased item(s) are sent to the other device phone. Examples of purchased items that can be delivered to other devices comprise ring tones, software, electronic maps, electronic games, audio (e.g., music), video, printed matter (e.g., books and other publications), multimedia content etc.

In some embodiments, the content displayed on the other device may comprise machine-readable content such as a bar code (which can be one or multidimensional), or OCR text, etc., which, e.g., can be read by a scanner, or the interactive content may comprise an optical signal which can be read by a photo detector or an IR detector, etc., or an audio signal, e.g., a DTMF signal, etc.

Various embodiments of the invention comprise methods, systems, and computer program products which implement the functionality described herein.

The processing referred to herein may be executed by at least one computer having access to storage device(s) and/or memory which stores content, e.g., advertising, consumer, multimedia, and other content and programming, on a computer readable medium or media. The at least one computer may comprise a server, a web server, a host computer, etc.

A method according to an embodiment of the invention comprises displaying on a TV device configured for interactive operation with an input device such as a remote control (e.g., a TV device comprising a TV and a STB connecting in a cable TV or other TV system) content that can be interacted with via the input device. Interaction of the input device and the TV device causes a request to be associated with an electronic address of a device such as a mobile device or computer device. Content relating to the request is assembled and sent to the electronic address of device and displayed, or in the case of an electronic item, saved or run. The content may comprise content disclosed herein and the device may comprise the devices disclosed herein.

Revenue streams in accordance with embodiments of the invention may be based on any interactivity related to display of frames that support or lead to display of frames that include interactive content. For example, a party such as an advertiser or advertising agency, etc., or TV channel operator or cable system operator, etc., may be charged for such interactivity. Embodiments of the invention provide for software and/or equipment to track such interactivity and a billing system for invoicing such parties. Regarding billing for items purchased as described herein, software and/or equipment may track and report such purchases to the vendor, etc. In such embodiments, provision is made to associate a purchase with credit or debit card information, or other information, for the benefit of the vendor.

### BRIEF DESCRIPTION OF THE DRAWINGS

The invention is illustrated in the figures of the accompanying drawings, which are meant to be exemplary and not limiting, and in which like references are intended to refer to like or corresponding structure and/or functionality, etc.

FIG. 1 is a block diagram depicting an exemplary system with which embodiments of the invention may at least partially be implemented, including a remote control, a TV, an STB, a cell phone, a computer (which may comprises one or more computers, servers, etc.) for handling advertising, text messaging, and multimedia messaging, and network connections between the components, according to one or more embodiments of the invention.

FIG. 2 is a block diagram of a process for generating interactive content and sending the interactive content from the cable television device to another device (a mobile device in this embodiment), according to one or more embodiments of the invention.

FIG. 3 depicts an exemplary screen image displayed on a TV for the purpose of sending interactive content from the cable television device to the mobile device, according to one or more embodiments of the invention.

FIG. 4 depicts two exemplary frames or images displayed on a TV for the purpose of requesting interactive content to be sent to a mobile device, where user input in a first frame leads to a second frame, and user input to in second frame requests interactive content, according to one or more embodiments of the invention.

FIG. 5 depicts two exemplary frames displayed on a TV for the purpose of requesting interactive content to be sent to a mobile device, where each frame includes lines displaying TV content such as a television show and lines displaying interactive content, although the interactive content can alternatively be displayed overlaying the TV content, according to one or more embodiments of the invention.

FIG. 6 depicts an example of interactive content being to a mobile device, according to one or more embodiments on the invention.

FIG. 7 depicts exemplary frames including interactive content displayed on a TV illustrating navigation to select content related to an electronic marketplace that is to be sent to a mobile device, according to one or more embodiments of the invention.

FIG. 8 depicts exemplary frames including interactive content displayed on a TV illustrating navigation to select multimedia content that is to be sent to a mobile device, according to one or more embodiments of the invention.

### DETAILED DESCRIPTION

The promise of interactive television has largely been unfulfilled for three key reasons: lack of standards, limited technical capabilities, and the difficulty of managing third party applications. These impediments have suppressed TV content providers from gaining incremental revenue from brand advertisers demanding targeted reach and measurable results for their media buys. Currently, advertisers spend billions of dollars each year in traditional television advertising, but have created new budgets for advertising on other platforms, including online and mobile platforms, to better connect with consumers and realize returns on advertising dollars. Embodiments of the invention provide for a TV-centric application that is platform agnostic, generates revenue, and provides reach for advertisers by better connecting with consumers, thereby allowing advertiser's brands to reach current and potential consumers for direct response and further engagement. Embodiments of the invention also provide for bridging TV content and content for other devices, e.g., a mobile device, by using the other device or the TV remote to navigate television content and transmit the content to a other device, thereby avoiding the need for paper or pen and allowing a consumer to receive content on-demand, sent to a convenient, platform.

Embodiments of the invention may be implemented using a set-top box (“STB”) used to control a TV, e.g., a cable box sold by companies such as Motorola and Scientific Atlantic; or may be implemented using a digital video recorder sold by companies such as Tivo and Moxi; or may be implemented using any TV or multimedia device used to display content. The STB may be connected to a variety of input sources, such as cable TV, satellite TV, telephone company TV, or IPTV, and may display content from a variety of content providers including broadcast, basic cable networks, and premium channels. A television viewer or consumer (“consumer”) may be presented with an advertisement or other message generated by the cable provider or third party, either through the cable provider's own advertising system, or a third party advertising/content system. Using a standard remote control connected to the TV through any standard connection method, e.g., infrared or radio frequency, the consumer may enter his or her mobile telephone number in response to a prompt on the screen.

In one or more embodiments, the STB may transmit the consumer's electronic address to a remote server, at the consumer's request, for the purpose of obtaining more information related to advertising. The STB may also transmit data related to the advertisement which was displayed on screen at the time the consumer's electronic address was transmitted, such as which advertisement the user clicked on or which contact options the user specified. The STB may also transmit data related to the consumer, such as the consumer's name, address, viewing habits, or purchasing preferences.

In one or more embodiments, the remote server generates content in a format compatible with the other device, e.g., an SMS or MMS for a cell phone, and transmits the content to the other device associated with the electronic address of the consumer. The content may be a text message, a picture message, or any other text or multimedia content, as supported by the other device and the network within which the device operates, e.g., a cell phone and a mobile phone network.

In one or more embodiments, the content may comprise interactive content related to the advertisement displayed on the TV.

In one or more embodiments, the advertising screen presented to the consumer may be coupled with an electronic marketplace, and the interactive content coupled with the content to be transmitted may include content related to the electronic marketplace.

Embodiments of the invention may be implemented by systems using one or more programmable STBs, digital computers, and computer readable storage media. In some embodiments of the invention, the other device comprises a mobile device. Systems which provide content t a mobile device may include a TV, a TV remote control, an STB, a cell phone, a server for handling advertising, text messaging, and multimedia messaging, and network connections between these components.

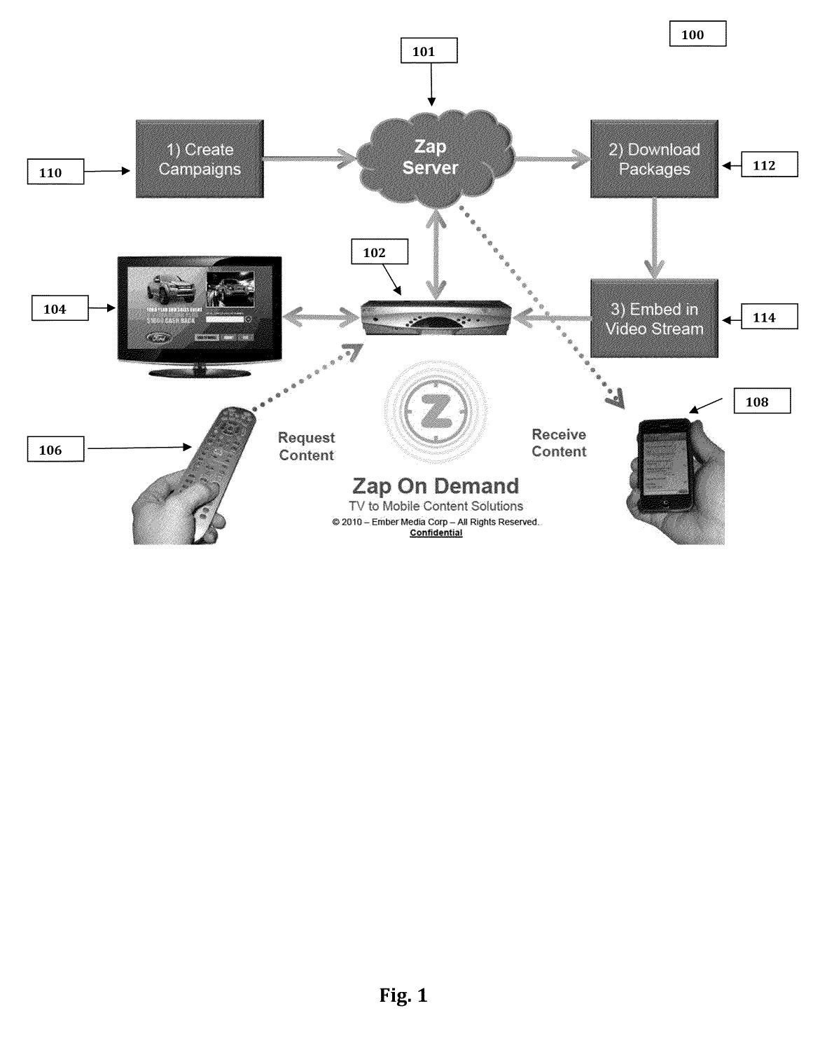

FIG. 1 is a block diagram depicting an embodiment of a system 100 with which embodiments of the invention comprising a mobile device may at least partially be implemented. System 100 includes server 101 for handling advertising, text messaging, and multimedia messaging, STB 102, TV 104, remote control 106, mobile device 108, and network connections between these components.

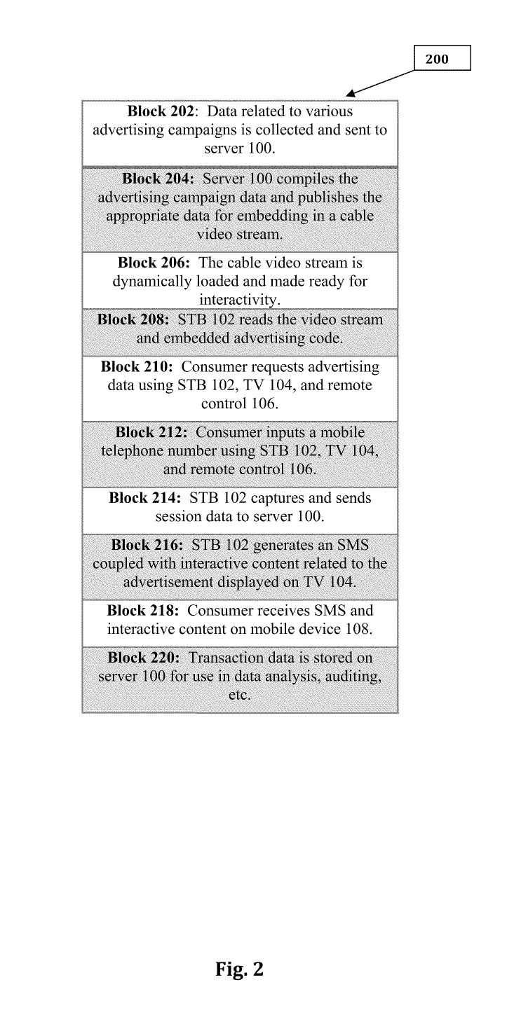

In an embodiment, data 110 related to various advertising campaigns is collected and sent to server 101. Server 101 compiles the advertising campaign data into download packages 112, embedded in video streams, and transmits the streams to STB 102. User input from remote control 106 to STB 102 based on content displayed on TV 104 provides consumer information such as a telephone number to the STB 102, which provides the information to server 101. The server 101 in turn transmits content related to the advertising campaign data 110 to mobile device 108, e.g., via a cell phone network based on the consumers telephone number. The flow relating to FIG. 1 is described in more detail below with reference to FIG. 2.

In the embodiment of FIG. 1, according to some embodiments, existing OnDemand functionality provided by the cable provider at the cable provider's headend is utilized to provide the described functionality. Server 101 communicates with the cable provider's STB 102 through an application programming interface (API), and the server transmits the concerned content to a designated Integrated Services Digital Network (ISDN). Data on the cable network may be transmitted over a cable network using any protocol, e.g., Enhanced Binary Interchange Format (EBIF).

In FIG. 1, in one or more embodiments, server 101 includes at least one processor such as an Intel or Advanced Micro Devices microprocessor, coupled to a communications channel and/or network. Server 101 further includes at least one computer readable medium or data storage device such as a magnetic disk or an optical disk and memory such as Random-Access Memory (RAM), each coupled to the communications channel.

One skilled in the art will recognize that many variations of server 101 are possible, e.g., server 101 may include multiple channels or buses, various arrangements of storage devices and memory, as different units or combined units, one or more computer-readable storage medium (CRSM) readers, such as a magnetic disk drive, magneto-optical drive, optical disk drive, or flash drive, and multiple components of a given type, e.g., processors, input devices, communications interfaces, etc.

In one or more embodiments, server 101 communicates over a network with at least one another computer, which may comprise one or more host computers and/or server computers and/or one or more other computers performing host and/or server functions including web server and/or application server functions. In one or more embodiments, a database is accessed by the at least one other computer, and the database may include advertising content, interactive content, multimedia content, data analysis content, or other content. The at least one other computer may include components as described for server 101, and other components as are well known in the computer arts. A network coupling server 101 to the at least one other computer may comprise one or more LANS, WANS, intranets, the Internet, and other networks known in the art. In one or more embodiments, server 101 is configured as a workstation that communicates with the at least one other computer over a network. In one or more embodiments, server 101 is configured as a client in a client-server system in which the at least one other computer comprises one or more servers.

The terms “client” and “server” may describe programs and running processes instead of or in addition to their application to computer systems described above. Generally, a (software) client may consume information and/or computational services provided by a (software) server.

FIG. 2 is a flow diagram of a process 200 for generating content and sending the content from the cable television device to another device, according to one or more embodiments of the invention. In this embodiment, the other device comprises a mobile device and the content is interactive.

In block 202, in an embodiment, data related to various advertising campaigns is collected and sent to server 101.

In block 204, in an embodiment, server 101 compiles the advertising campaign data and publishes the appropriate data for embedding in a cable video stream.

In block 206, in an embodiment, the cable video stream is dynamically loaded and made ready for interactivity.

In block 208, in an embodiment, STB 102 reads the video stream and embedded advertising code.

In block 210, in an embodiment, the consumer requests advertising data using STB 102, TV 104, and remote control 106.

In block 212, in an embodiment, the consumer inputs a mobile telephone number using STB 102, TV 104, and remote control 106.

In block 214, in an embodiment, STB 102 captures and sends session data comprising the telephone number and other data in to server 101.

In block 216, in an embodiment, STB 102 generates an SMS (or an MMS) comprising interactive content related to the advertisement displayed on the TV.

In block 218, in an embodiment, the mobile device 108 of the consumer receives the SMS (or MMS) and displays interactive content.

In block 220, in an embodiment, transaction data is stored on server 101 for use in data analysis, auditing, etc.

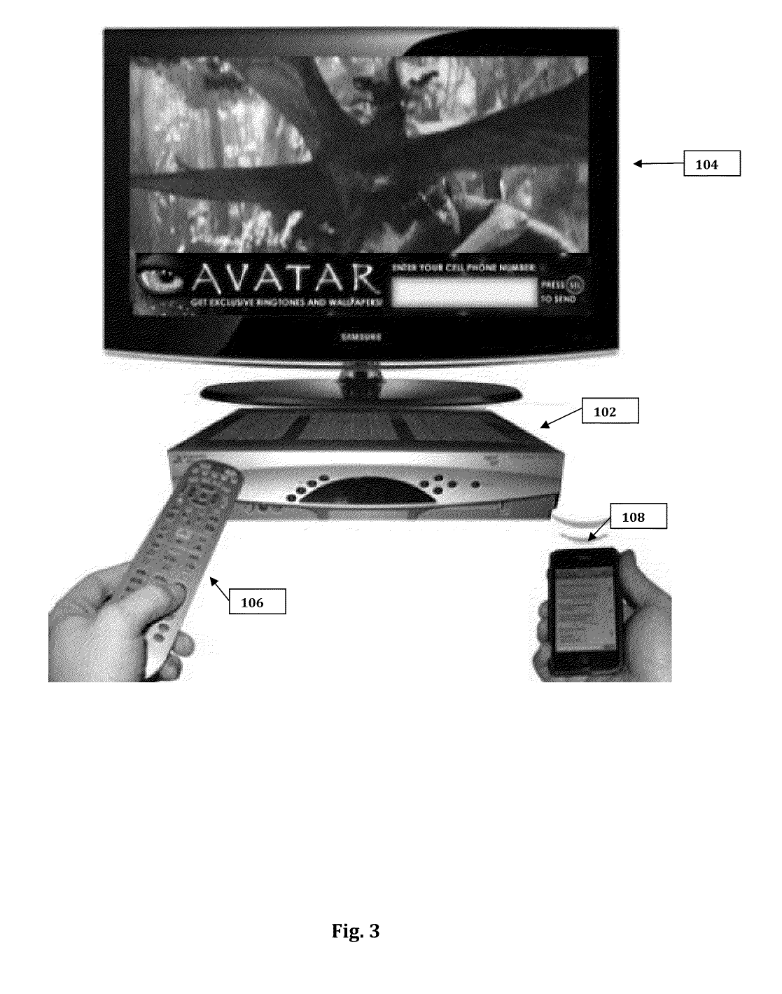

FIG. 3 illustrates an exemplary frame displayed on a TV 104 which includes interactive content that can be used to request information, i.e., content. Lines in the upper portion of the frame display a TV program and lines at the bottom of the frame display the interactive content. In another embodiment, the interactive content be displayed anywhere in the frame. The interactive content appears to overlay the program content, e.g., as an overlay banner. As illustrated, a user operates the remote control 106 to enter information into the STB 102 which is displayed in interactive portion of the screen, as is conventional. Then the STB 102 transmits the information and other data to the server 101, which then provides the content to the cell phone 108. In another embodiment, a user input information designating a stored mobile telephone number to avoid the process of entering a telephone number once an initial registration process has been completed. In another embodiment, a user may use the mobile telephone number associated with the cable provider's billing system to avoid the process of entering a telephone number.

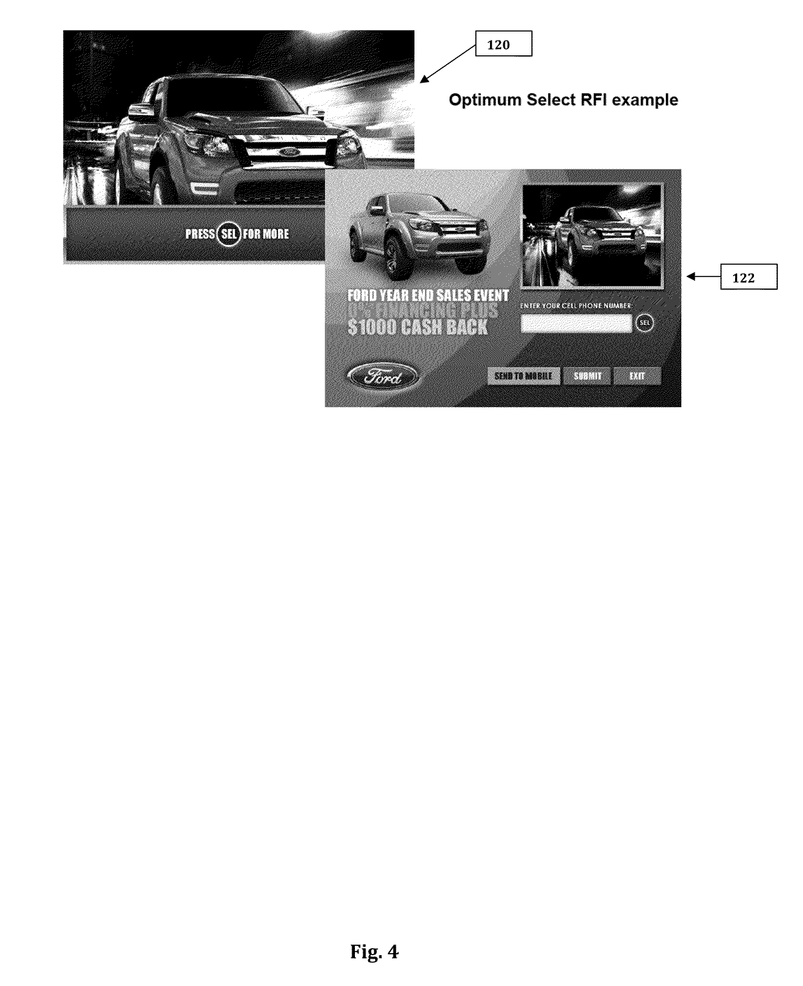

FIG. 4 depicts two exemplary TV frames 120, 122 which can be displayed on TV 104. A first frame 120 includes content (“Press SEL For More”) informing a user that he or she can request more information by pressing the select button on the remote control. In response to selection of the select button, the second screen 122 is displayed, which includes interactive content for entering a telephone number, similar to the Frame displayed in FIG. 3, except that the frame 122 includes advertising and does not include a TV program. A user can at least interact with frame 122 as described above in connection with FIG. 3. Frame 122 also includes other interactive content in the form of selectable tabs or buttons which can be navigated to in conventional fashion by buttons on the remote control. For example, the actions “Send to Mobile,” “Submit,” or “Exit” can be selected.

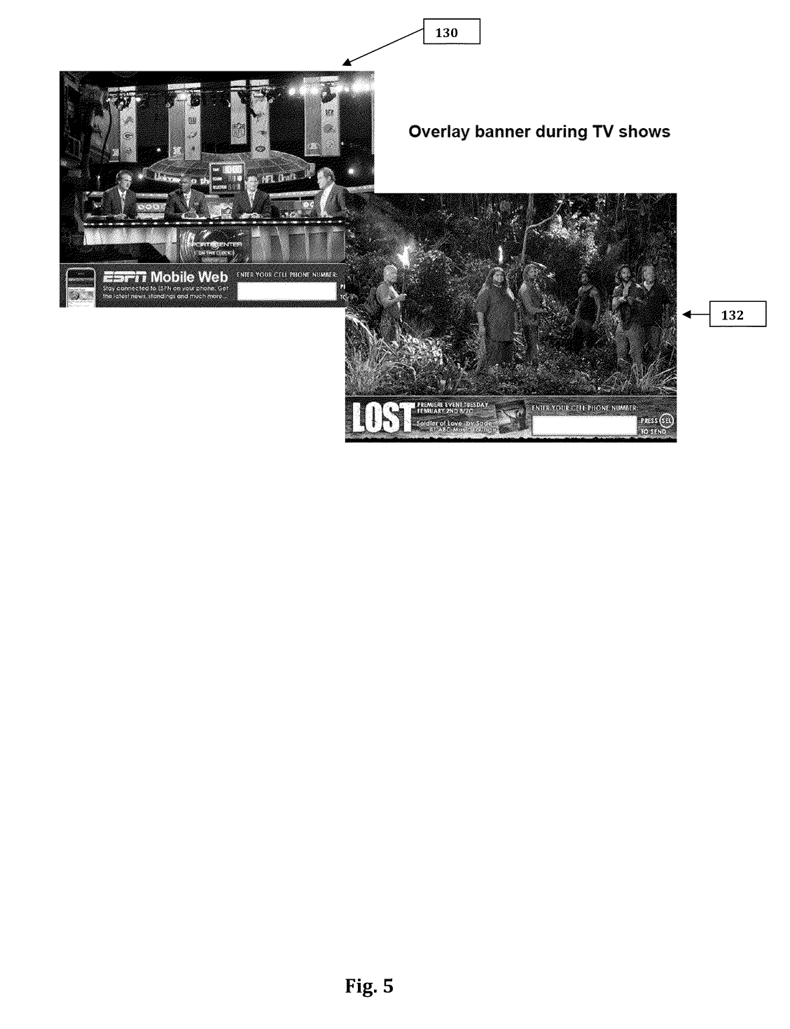

FIG. 5 depicts two exemplary TV frames 130, 132 which can be displayed on a TV 104. Frames 130, 132 are similar to the frame depicted in FIG. 3 where the interactive content appears at the bottom of a TV program frame and appears to overlay the program content, e.g., as an overlay banner. Navigation and user input proceed in conventional fashion generally as described above. In the embodiment depicted in FIGS. 3 and 5, information can be requested by a user without interrupting the normal content being displayed on the TV, thereby increasing the chance that viewer will further engage an advertisement.

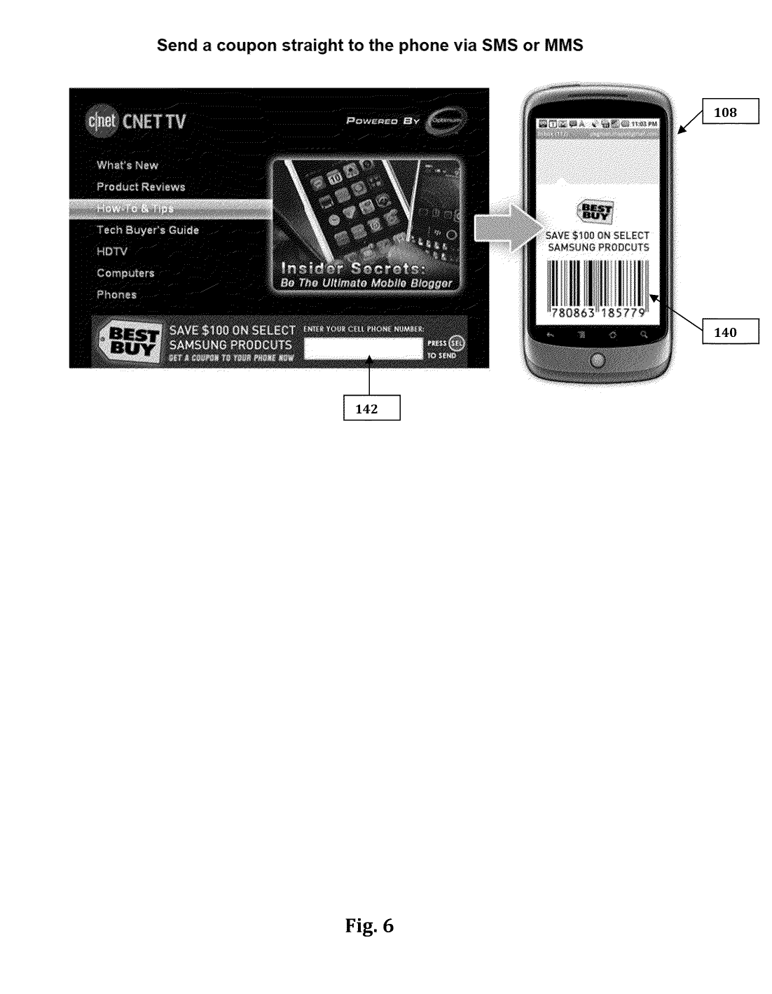

FIG. 6 illustrates interactive content 140 requested from a frame 142 that was displayed on a TV 104 being sent to a cell phone 108, according to one or more embodiments of the invention. The frame 142 represents an advertisement with the interactive portion at the bottom of the frame. In this embodiment, the interactive content 140 provided to the cell phone 108 comprises a bar code, which, as discussed above, is machine-readable content. In this embodiment, the bar code is part of a coupon that can be redeemed by the advertiser identified in the interactive portion of the frame 142. Coupons displayed on an electronic device may be redeemed in convention fashion. In some embodiments, the interactive content may have value, e.g., as represented by a coupon, or an event entry ticket, or a voucher, or a gift certificate, etc. In other embodiments, the interactive content 140 may comprise a text message or picture message, which may or may not include an internet URL or link to multimedia content.

In yet another embodiment, the interactive content may include regular advertising campaigns and promotions, text, photos, graphics, music, video clips, animations, other web links, e-books, software apps, screensavers, wallpaper files, ringtones, mobile games, and information or content related to mobile commerce.

According to one embodiment of the invention, the interactive content may relate to the television show or music video displayed on the TV. According to another embodiment of the invention, the interactive content may relate to product information, such as descriptions, pictures, or videos of a consumer product. According to another embodiment of the invention, the interactive content may relate to community information such as local events, regional newspaper articles, or town meetings.

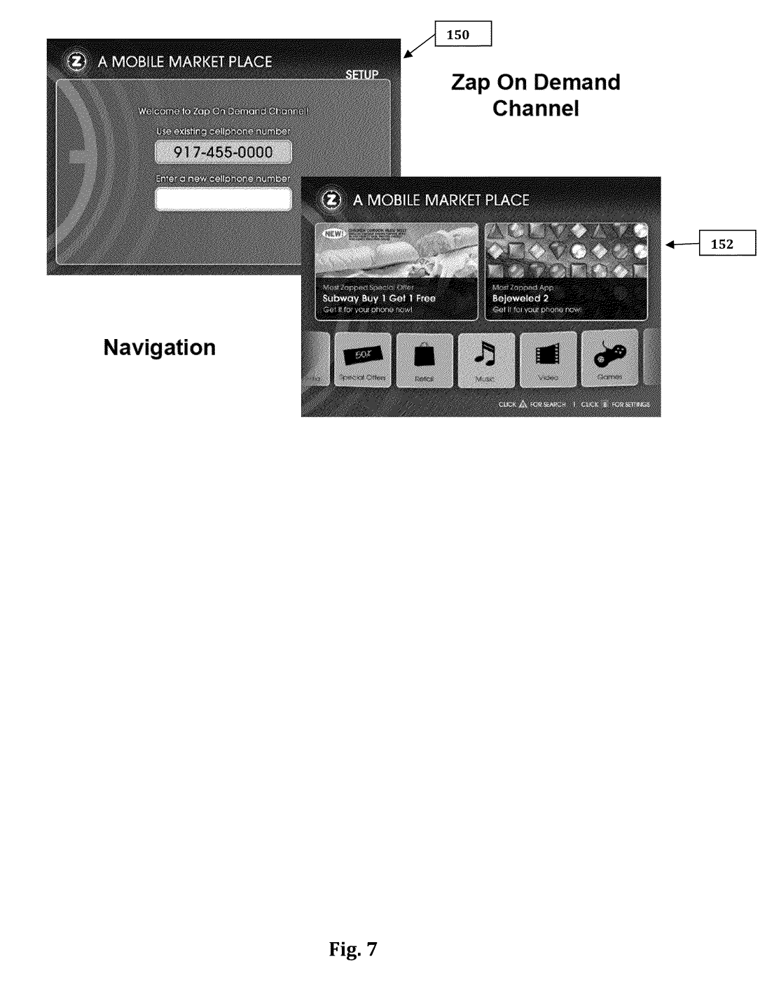

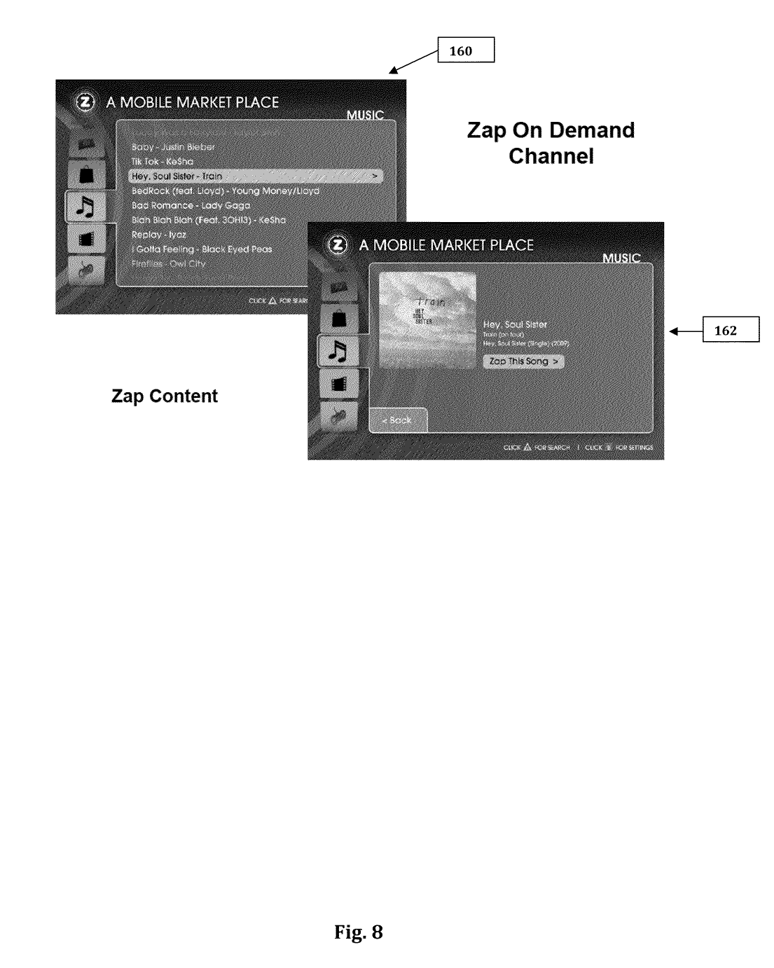

FIGS. 7 and 8 depict four exemplary TV frames 150, 152 (FIGS. 7) and 160, 162 (FIG. 8), which can be displayed on a TV 104. In this embodiment, the frames are part of a marketplace which is directed to consumer interactive TV shopping, similar to home shopping channels currently distributed over cable. For example, the marketplace may include content related to retail, music, video, gaming, and other products. In this embodiment, either the purchased item(s) or content which can be used to retrieve the purchased item(s) are sent to the cell phone.

Frame 150 in FIG. 7 comprises set-up content, e.g., the viewer's telephone number. Once the viewer enters or selects a telephone number, navigation proceeds to screen 152, where a viewer may select categories of items which he or she may want to purchase. For example, five categories (“Special Offers,” Retail,” “Music,” “Video” and “Games”) are shown at the bottom of frame 152 as part of a ticker-like movable display with additional categories. Selection of the “Music” category in frame 152 (“Music” is shown highlighted) by interactive use of the remote control 106, as described above, causes navigation to proceed to frame 160 depicted in FIG. 8, which lists titles of songs that can be purchased. Selection of a song title (“Hey, Soul Sister-Train” by interactive use of the remote control 106, as described above, causes a request for the song to be transmitted to server 101, along with other information, e.g., information described above. Content sent to the mobile device comprises the song. Examples of purchased items that can be delivered to a mobile or other device comprise ring tones, software, electronic maps, electronic games, audio (e.g., music), video, printed matter (e.g., books and other publications), multimedia content, etc.**

In one or more embodiments, cable providers or other parties associated with operation of the STB may couple the electronic marketplace to a billing system to charge consumers a set or variable fee for each transaction, i.e., each purchase/SMS or MMS initiated from the STB by a consumer in response to the electronic marketplace on the STB.

In one or more embodiments, cable providers or other parties associated with operation of the STB may couple the interactive advertising system to a billing system to charge advertisers a set or variable fee for each transaction, i.e., each SMS (or MMS) initiated from the STB by a consumer in response to an advertisement on the STB.

In one or more embodiments, cable providers or other parties associated with operation of the STB may couple the system to a data collection and analysis system to analyze data associated with the advertising or SMS (or MMS) transmissions.

As discussed above, other devices may comprise devices which can receive content over a network, including mobile devices such as a standard cell phone, or smartphone with PC-like functionality (collectively “cell phone”), and computer devices such as personal digital assistants, laptop and palm computers, tablet computers, PCs, etc. Embodiments have been described above in connection with mobile devices. Embodiments in which the other device comprises a computer device operate in similar fashion. In one embodiment, a viewer enters an email address, and the system process the email addresses and sends the content to an email account. The viewer can then retrieve the content in conventional fashion. Similarly, a viewer can enter web server address, and the content is sent to the web server. In these embodiments, the STB 102 provides the information to a server 101 which is programmed to recognize and distinguish telephone numbers, email addresses and web server addresses, and to then format the content to be sent to other device appropriately for the other device and the network over which the content is to be transmitted.

While the invention has been described and illustrated in connection with embodiments, many variations and modifications as will be evident to those skilled in this art may be made without departing from the spirit and scope of the invention as defined by the claims, and the invention is thus not to be limited to the precise details of methodology or construction set forth above as such variations and modifications are intended to be included within the scope of the invention as defined by the claims.

What is claimed is:

1. A method of sending interactive content from a cable television device to another device comprising:
receiving an input request from a consumer in response to content displayed on a TV;
transmitting the consumer's input request and an electronic address to at least one computer;
the at least one computer generating content in a format compatible with the other device; and
transmitting the content to the other device associated with the electronic address.

2. The method of claim 1, wherein the content comprises interactive content and in some embodiments the interactive content is related to the content displayed on the TV.

3. The method of claim 1, wherein the electronic address comprises telephone information and/or email information, and/or an Internet address, or a web server address.

4. The method of claim 1, wherein the compatible format comprises SMS, or MMS, or email, or URL, or a web page.
